(19) United States
(12) Patent Application Publication
(10) Pub. No.: US 2009/0265374 A1
(43) Pub. Date: Oct. 22, 2009

(54) Method For Generating Access Statistic Data On Individual Visitor To Web Site

(75) Inventor: Yong Jung Bang, Daegu (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: LOG CORP., Daegu (KR)

(21) Appl. No.: 12/494,549

(22) Filed: Jun. 30, 2009

Related U.S. Application Data
(63) Continuation of application No. PCT/KR2009/001474, filed on Mar. 23, 2003.

(30) Foreign Application Priority Data
Mar. 24, 2008 (KR) 10-2008-0026991

(51) Int. Cl. G06F 17/30

(52) U.S. Cl. 707/102; 707/E17.009; 707/104.1

(57) ABSTRACT

A method for generating access statistic data on each visitor to a web site includes (a)when a visitor terminal accesses the web site, reading unique ID from userdata file of xml in which data can be stored and retrieved by using userData Behavior; (b) when access history of the visitor terminal having unique ID in step (a) is stored in an access statistics DB, updating the access history of the visitor terminal in the DB with unique ID; and (c)when unique ID is not readout in step (a) or the access history of the visitor terminal having unique ID in step (a) is not stored in the DB, generating unique ID corresponding to the visitor terminal, generating userdata file where unique ID is written and storing userdata file in the visitor terminal, and storing the access history of the visitor terminal in the DB with unique ID.

### CROSS REFERENCE TO RELATED APPLICATIONS

The present application is a continuation of International Application No. PCT/KR2009/001474, filed Mar. 23, 2009 which claims the benefit of Korean Patent Application No. 10-2008-0026991, filed Mar. 24, 2008. The disclosures of said applications are incorporated by reference herein.

### TECHNICAL FIELD

The present invention relates to a web site visitor analysis system and a method thereof; and, more particularly, to a system and a method for analyzing access information of each visitor to a web site.

### BACKGROUND OF THE INVENTION

Generally, a web site such as an Internet portal site or an E-commerce site collects and analyzes access logs of visitors to the web site for customer management and statistical analysis. A frequently used method therefor is to collect access information of an already registered visitor when the visitor logins to the web site. Further, there is also known a method for identifying a visitor and analyzing access information of the visitor by reading an IP address or a cookie of the visitor when the visitor accesses the web site without login.

FIG. 1 is a block diagram of an access log collecting system in accordance with the prior art. As depicted in FIG. 1, the conventional access log collecting system includes a visitor terminal 10 and a web site 20. The visitor terminal 10 and the web site 20 are connected with each other via a network such as Internet or the like.

The visitor terminal 10 has an IP address 13 for Internet access. Further, the visitor terminal 10 is also provided with a web browser 11 for Internet browsing. Further, a cookie 12 used for collecting access information by the web site 20 is also stored in the visitor terminal 10.

Further the web site 20 includes a web server 21 and an access statistics DB 22. Furthermore the access statistics DB 22 stores therein login information of the visitor, a total access statistic of the web site 20, and so forth.

When the visitor terminal 10 accesses and logins to the web site 20, the web server 21 searches for visitor data corresponding to the login information from the access statistics DB 22 and then identifies the visitor terminal 10. Further, the web server 21 collects access information on the identified visitor terminal 10, and the collected access information is stored in the access statistics DB 22.

Typically, when the visitor terminal 10 accesses the web site 20 without login, there has been employed a technique for analyzing the access information of the visitor terminal 10 by using the IP address 13.

For example, when the visitor terminal 10 accesses the web site 20 without login, the web site 20 determines whether the IP address 13 of the visitor terminal 10 is stored in the access statistics DB 22. Further, in case that the IP address 13 is stored, the web site 20 recognizes that the visitor terminal 10 has re-accessed the web site 20, whereas in case that the IP address 13 is not stored, the web site 20 recognizes that the visitor terminal 10 has made an initial access.

In case of the initial access, new visitor data is generated in the access statistics DB 22 and stored in combination with the IP address of the visitor terminal 10. Thus, if a visitor terminal 10 having the same IP address 13 accesses the web site 20, such access can be recognized as a re-access.

Meanwhile, when the visitor terminal 10 accesses the web site 20 without login, there has been also employed a method for analyzing the access information of the visitor terminal 10 by using a cookie 12.

For example, when the visitor terminal 10 accesses the web site 20, the web server 10 reads information in the cookie 12 of the visitor terminal 10 and determines whether the visitor terminal 10 has an initial access or a re-access to the web site 20.

Here, a cookie is a temporary file generated when a customer visits a certain web site or a homepage. The cookie is generated in the visitor terminal 10 by the web server 21 at the moment the visitor terminal 10 accesses the web server 21 or after authentication is granted. The cookie contains various information of the visitor, and the type of the cookie is varied depending on a prescribed rule of the web server 21.

A manager of the web site 20 can be informed of the number of visitors to the web site 20, interests of the visitors, and the like by analyzing access history information stored in the access statistics DB 22. Further, the manager can use the access history information as important data for the efficient management of the web site 20.

According to the prior art, however, in the event that the IP address 13 is changed or the cookie 12 is deleted, the visitor terminal 10 whose IP address 13 is changed or whose cookie 12 is deleted has been recognized as a first visitor even when the visitor terminal 10 has re-accessed the web site 20. Accordingly, it has been impossible to generate access statistics accurately.

Particularly, as the usage of dynamic IP addresses and the distribution of security programs are generalized recently, the cookie is frequently deleted. Thus, it becomes more difficult to generate exact access statistics.

As Patent Document 1, disclosed in Korean Patent Application No. 2005-12355 is an invention titled “Integrated web site management system and management method using the same.” The invention enables a display of log information and a search result of a visitor to the web site 20 on a single screen, thus facilitating an analysis thereof. Further, the invention provides the integrated web site management system and the management method using the system capable of modifying content data of the web site on a real time basis by using log analysis information and the search result.

As Patent Document 2, disclosed in Korean Patent Application No. 2007-1636 is an invention titled “Method for managing web page access history information.” In the invention, log data of a user of a web page is generated. Further, the log data is managed in a client terminal of the user, not in a separate management server. Accordingly, a load necessary for the management server to manage the log data can be reduced.

According to such prior art, however, only an access keyword, access date and time, and the like are recorded in a log analysis DB of the manager web site 20. Thus, by analyzing the total access statistic of the entire web site, only a cumulative statistic can be computed, failing to obtain log analysis information of each visitor.

### SUMMARY OF THE INVENTION

In view of the foregoing problems, the present invention provides a method for generating access statistic data on an individual visitor to a web site, capable of generating access statistic data on each visitor terminal to the web site by generating and storing in each visitor terminal an access information file in which a unique ID is written in addition to a cookie in which the unique ID is written.

The present invention also provides a real-time log analysis system and a method for an individual visitor to a web site, capable of generating statistic information usable in a management of customers visiting the web site, a management of the web site or an execution of advertisement by analyzing an access history of each visitor terminal when the same visitor terminal re-accesses the web site.

In accordance with one embodiment of the present invention, there is provided a method for generating access statistic data on an individual visitor to a web site, the method including: (a) when a visitor terminal accesses the web site, reading out a unique ID from a userdata file implemented in the form of xml (extensible markup language) in such a way that data thereof can be stored in and retrieved from the visitor terminal by using userData Behavior; (b) when an access history of the visitor terminal having the unique ID read out from the step (a) is stored in an access statistics DB, updating and storing the access history of the visitor terminal in the access statistics DB in combination with the read-out unique ID; and (c) when the unique ID is not read out from the step (a) or the access history of the visitor terminal having the unique ID read-out in the step (a) is not stored in the access statistics DB, generating a unique ID corresponding to the visitor terminal, generating a userdata file in which the generated unique ID is written and storing the generated user data file in the visitor terminal, and storing the access history of the visitor terminal in the access statistics DB in combination with the generated unique ID.

In accordance with another embodiment of the present invention, there is provided a method for generating access statistic data on an individual visitor to a web site, the method including: (a) when a visitor terminal accesses the web site, reading out a unique ID from a flash data file implemented in such a way that data thereof can be stored in and retrieved from the visitor terminal by using a SharedObject class of Macromedia Flash; (b) when an access history of the visitor terminal having the unique ID read out from the step (a) is stored in an access statistics DB, updating and storing the access history of the visitor terminal in the access statistics DB in combination with the read-out unique ID; and (c) when the unique ID is not read out from the step (a) or the access history of the visitor terminal having the unique ID read-out in the step (a) is not stored in the access statistics DB, generating a unique ID corresponding to the visitor terminal, generating a flash data file in which the generated unique ID is written and storing the generated flash data file in the visitor terminal, and storing the access history of the visitor terminal in the access statistics DB in combination with the generated unique ID.

In accordance with the present invention, even in case that an IP address of a visitor terminal is changed or a cookie file is deleted, it can be easily determined whether the visitor terminal accesses the web site for the first time or re-accesses.

In accordance with the present invention, even in case that an IP address of a visitor terminal is changed or a cookie file is deleted, access statistic data on each visitor terminal to the web site can be analyzed.

Furthermore, in the event that the same visitor terminal re-accesses the web site, an access history of the visitor terminal can be analyzed and can be utilized as information for the management of the customers visiting the web site, the management of the web site or the execution of advertisement.

### BRIEF DESCRIPTION OF THE DRAWINGS

FIG. 1 is a block diagram of a prior art access log collecting system;

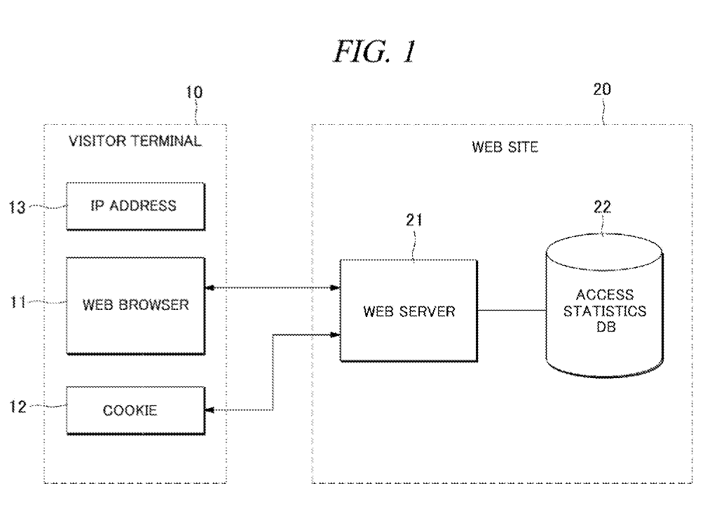

FIG. 2 is a block diagram of a system for generating access statistic data on an individual web site visitor in accordance with an embodiment of the present invention; and

FIG. 3 is a flowchart of a method for generating access statistic data on an individual web site visitor in accordance with an embodiment of the present invention.

### DETAILED DESCRIPTION

Hereinafter, embodiments of the present invention will be described in detail with reference to the accompanying drawings so that the present invention may be readily implemented by those skilled in the art. However, it is to be noted that the present invention is not limited to the embodiments but can be realized in various other ways. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements.

For example, in order to research the floating population, the number of passersby is counted with naked eyes and statistics are gathered. It is assumed that for one day, a total of 100 people pass by and there are 30 men and 70 women among them.

When the statistics are generated just by the naked eyes, it is impossible to collect statistics on people who pass by more than one time. It is similar to a case of counting only the total access number of all visitors without considering re-accesses of respective visitor terminals.

Further, it may be also considered to attach an identifier such as a sticker or the like to cloths of people to count the number of passersby who pass by more than one time. In such case, however, if the people change cloths or the stickers are removed, it is impossible to identify same person. It is similar to the case where the cookie of the visitor terminal is removed or the IP address thereof is changed.

The present invention can be compared to a case of inserting an electronic chip into the body of each of all the passersby. That is, by assigning their own not-to-be-deleted IDs to each of all the passersby, it is possible to generate statistics that 20 people among 70 women pass by two times for a day, and one person passes by three times and one person passes by four times.

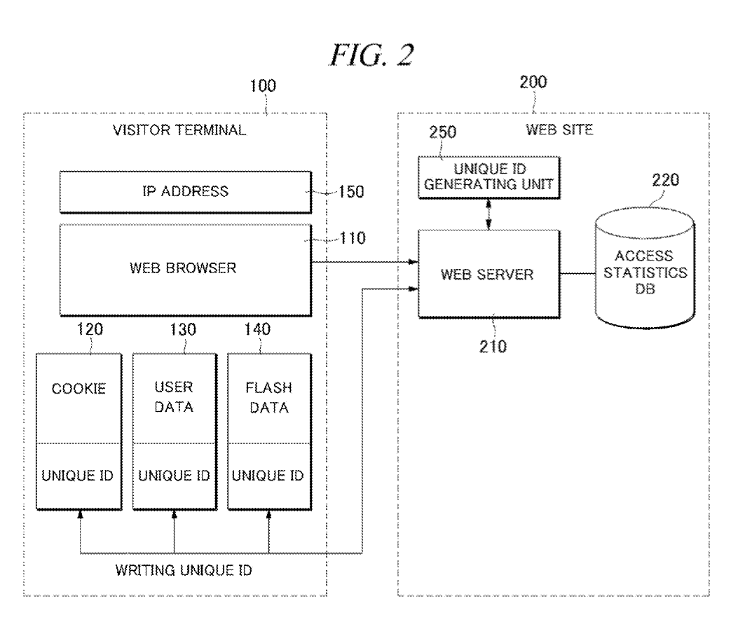

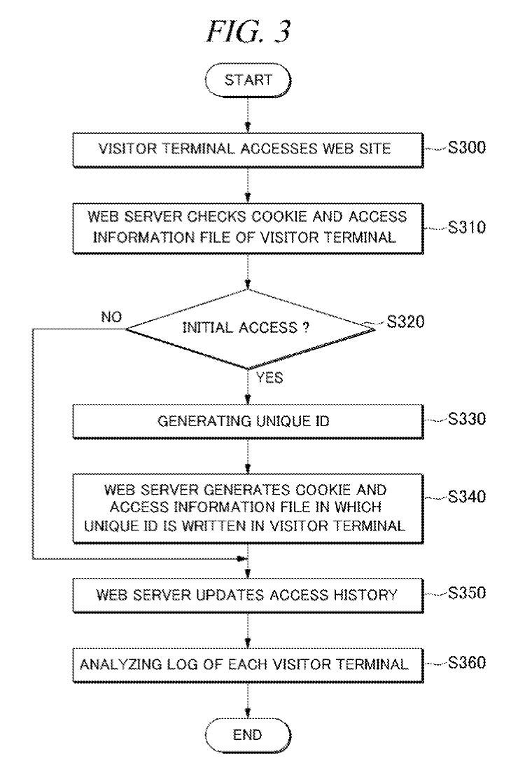

Hereinafter, an embodiment of the present invention will be described in detail with reference to FIGS. 2 and 3.

FIG. 2 is a block diagram of a system for generating access statistic data on an individual web site visitor in accordance with an embodiment of the present invention.

Referring to FIG. 2, the system for generating access statistic data on an individual web site visitor in accordance with the embodiment of the present invention mainly includes a visitor terminal 100 and a web site 200. Further, the visitor terminal 100 and the web site 200 are connected with each other via a network such as wired or wireless Internet or the like.

The visitor terminal 100 includes, for example, a desktop computer, a notebook computer, a laptop computer and a personal portable terminal. The portable terminal includes all kinds of handheld wireless communication apparatuses such as PCS (Personal Communication System), GMS (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Interne) terminals.

The network includes a wired network such as LAN (Local Area Network), WAN (Wide Area Network), VAN (Value Added Network) or the like, or all kinds of wireless network such as a mobile radio communication network, a satellite network, a bluetooth, Wibro (Wireless Broadband Internet), HSDPA (High Speed Downlink Packet Access) or the like.

The visitor terminal 100 has an IP address 150 for Internet access, and a web browser 110 for Internet browsing is provided in the visitor terminal 100. Further, a cookie 120 and access information files 130 and 140 for writing and reading out data are stored in the visitor terminal 100, and a unique ID is written in the cookie 120 and the access information files 130 and 140 respectively, and stored paths of the access information files 130 and 140 are different from that of the cookie 120.

The cookie 120 and the access information files 130 and 140 in which the unique ID is written contain various information for collecting access information on the visitor terminal 100.

Meanwhile, the web site 200 includes a web server 210 and an access statistics DB 220. Further, the access statistics DB 220 stores therein statistic data on every individual visitor to the web site 200.

The visitor terminal 100 can access the web site 200 through the web browser 110. Further, the website 200 can determine whether the visitor terminal 100 has made an initial access or a re-access to the web site 200. In case of the initial access, the visitor terminal 100 receives from the web site 200 the cookie 120 and the access information files 130 and 140 in which the unique ID is written. The access information files 130 and 140 will be described later in further detail.

When the visitor terminal 100 accesses the web site 200, the web server 210 s whether the visitor terminal 100 accesses initially or re-accesses by referring to the IP address 150, the cookie 120 and the access information files 130 and 140 of the visitor terminal 100.

For example, the web server 210 searches for an access log indicating a previous access of the visitor terminal 100 to the web site 200 by comparing the IP address 150 of the visitor terminal 100 with the data stored in the access statistics DB 220. When there exists an IP address identical with the IP address 150 of the visitor terminal 100 among the IP addresses stored in the access statistics DB 220, it is determined that an access log exists. However in case that there is no same IP address, it is determined that the access log does not exist.

When there is found no access log as a result of the comparison of the IP addresses, the web server 210 searches for an access log indicating the previous access of the visitor terminal 100 to the web site 200 by comparing the information in the cookie 120 with the data of the access statistics DB 220. For example, in case that the same ID as the unique ID written in the cookie 120 is stored in the access statistics DB 220, it can be determined that the access log exists. However, in case that no ID identical with the unique ID written in the cookie 120 is stored in the access statistics DB 220 or there exists no cookie 120, it can be determined that there exists no access log.

As a result of the comparison of the cookie information, when there is no access log, the web server 210 searches for an access log indicating the previous access of the visitor terminal 100 to the web site 200 by comparing the information in the access information files 130 and 140 with the data of the access statistics DB 220. For example, when the same ID as the unique ID written in the access information files 130 and 140 is stored in the access statistics DB 220, it can be determined that the access log exists. Further, in case that no same ID as the unique ID written in the access information files 130 and 140 is stored in the access statistics DB 220 or there exists no access information file 130 or 140, it can be determined that the access log does not exist.

So far, though the web server 210 has been described to perform the search for the access log in the order of the IP address 150, the cookie 120 and the access information files 130 and 140, the present invention is not limited thereto. That is, the order for searching for the access log can be changed. Moreover, if there exist an IP address or an ID coincident with at least one of the IP address 150 and the unique IDs written in the cookie 120 and the access information files 130 and 140, respectively, it can be determined that the access log exists. However, it is not necessary that all of the IP address and ID should be coincident with the IP address 150 and the unique IDs written in the cookie 120 and the access information files 130 and 140, respectively. Furthermore, in case that there is no IP address and ID coincident with the IP address 150and the unique IDs written in the cookie 120 and the access information files 130 and 140, respectively, it can be determined that there exists no access log.

Below, there will be explained an operation of the web site 200 when it is determined that the visitor terminal 100 accesses the web site 200 for the first time.

A unique ID generating unit 250 generates a unique ID for the visitor terminal 100. Then, the web server 210 generates a cookie 120 in which the unique ID is written and stores the generated cookie 120 in the visitor terminal 100. On the other hand, in case that the cookie 120 already exists but the ID written in the cookie 120 is not coincident with the generated ID, the web server 210 can write the generated ID in the already existing cookie 120 without generating a new cookie 120.

Further, the web server 210 generates access information files 130 and 140 in which the unique ID is written and then stores them in the visitor terminal 100. On the other hand, in case that the access information files 130 and 140 already exist but the ID written in the access information files 130 and 140 is not coincident with the generated ID, the web server 210 can write the generated ID in the already existing access information files 130 and 140 without generating new access information files 130 and 140.

Moreover, the web server 210 also generates an access history of the visitor terminal 100containing the unique ID in the access statistics DB 220. The generated access history is updated according to collected access information when the visitor terminal 100 having the unique ID re-accesses.

Below, there will be explained an operation of the web site 200 when it is determined that the visitor terminal 100 re-accesses the web site 200.

When it is determined that the IP address 150 is coincident with that stored in the access statistics DB 220, the web server 210 updates the access history of the visitor terminal 100 having the IP address 150 among the data stored in the access statistics DB 220, and then updates the cookie 120 and the access information files 130 and 140.

Now, the process of updating the cookie 120 and the access information files 130 and 140 will be described. For example, the web server 210 reads out the unique ID matching with the IP address 150 of the visitor terminal 100 from the access statistics DB 220. Thereafter, the web server 210 searches for the cookie 120. If there is found no cookie 120, the web server 210 generates a cookie 120 in which the read-out unique ID is written and then stores the generated cookie 120 in the visitor terminal 100. On the contrary, if the cookie 120 exists, the web server 210 updates the access information containing the unique ID and records it. Further, the web server 210 also searches for the access information files 130 and 140. If the access information files 130 and 140 are not found, the web server 210 generates access information files 130 and 140 in which the unique ID is written and then stores them in the visitor terminal 100. On the contrary, if the access information files 130 and 140 exist, the web server 210 updates the access information containing the unique ID and records it.

When it is determined that the unique ID written in the cookie 120 is coincident with the unique ID stored in the access statistics DB 220, the web server 210 updates the access history of the visitor terminal 100 having the unique ID among the data stored in the access statistics DB 220 and updates the access information files 130 and 140. Further, when the IP address is changed, the web server 210 records the changed IP address in the access statistics DB 220 in combination with the unique ID.

When the unique ID written in the access information files 130 and 140 is found to be coincident with the unique ID stored in the access statistics DB 220, the web server 210 updates the access history of the visitor terminal 100 having the unique ID among the data stored in the access statistics DB 220 and updates the cookie 120. Further, when the IP address is changed, the web server 210 records the changed IP address in the access statistics DB 220 in combination with the unique ID.

Now, the access information files 130 and 140 will be explained in detail. Either one of the access information files 130 and 140 may be used or more than one access information files may be used as illustrated.

The access information file 130 may be, for example, a userdata file. The userdata file contains basic and minimum information and is generated in the visitor terminal 100 by the web browser, just like cookie 120. The userdata file stores data in a different storing path from the cookie 120 in the visitor terminal 100 and has a larger storage size and a more variable structure than the cookie 120. That is, the userdata file is a kind of Internet temporary file containing updatable information by the web browser, just like the cookie 120. The userdata file can have a size of about 1 MB much greater than 1 KB which is a general size of the cookie. Though the cookie 120 is in the form of a text, the userdata file is in the form of xml (extensible markup language).

In the present specification, the userdata file can be handled under Internet Explorer environment by using userData Behavior which is a kind of function provided by Microsoft Corporation. More details relevant thereto are described in “http://msdn2.microsoft.com/en-us/library/ms531424.aspx.”

Further, the access information file 140 may be, for example, a Flash Data file. Data can be stored in the flash data file of the visitor terminal 100 and retrieved from the flash Data file of the visitor terminal 100 by using a SharedObject embedded class of Macromedia Flash. The flash data file is different from a cookie generally used in a java script or a server site script (php, asp, jsp, or the like). However, the flash data file can store data in the visitor terminal 100 like the cookie. The flash data file stores data in a Flash SWF file by using the SharedObject class of the Macromedia Flash when the operation of applications are stopped in the visitor terminal. Further, when the applications are operated again in the visitor terminal, the flash data file can load the stored data. The SharedObject class makes a reference to a shared object which is permanently stored in a local position and can be used only by a current application. In case that the SharedObject class cannot generate a reference to a shared object or search for a shared object, a getlocal( ) function returns a null. A storage path is, for example, C:\DocumentsandSettings\Administrator\ApplicationData\Macro media\FlashPlayer\#SharedObjects. Further, though a cookie generated by a general browser has a maximum storage size of about 4 KB, a basic value of the storage size of the flash data file is about 100 KB, and the storage size is indefinite and can be set by a user.

As already described above, both of the user data file 130 and the flash data file 140 can be used as the access information files 130 and 140, or either one of them can be used.

FIG. 3 is a flowchart for describing a method for generating access statistic data on an individual web site visitor in accordance with an embodiment of the present invention.

If the visitor terminal 100 accesses the web site 200 in step S300, the web server 210 checks at least one of an IP address, a cookie, an access information file (user data file and/or flash data file) of the visitor terminal 100 in step S310.

If it is determined in step S320 that the visitor terminal 100 accesses the web site 200 for the first time, the unique ID generating unit 250 generates a unique ID (step S330). Further, the web server 210 generates a cookie and an access information file (user data file and/or flash data file) in which the unique ID is written, and stores them to the visitor terminal 100 (step S340).

If it is determined in step S320 that the visitor terminal re-accesses the web site 200, the process proceeds to step S350.

In step S350, the web server 210 updates an access history of an individual visitor and stores it in the access statistics DB 220. Further, the web server 210 analyzes a log of the visitor terminal 100 and provides various statistic data to the manager of the web site 200 (step S360).

In accordance with the present invention, by assigning a unique ID to all of the visitor terminals 100 to the web server 210, it is possible to carry out an exact statistic analysis of the re-accessing visitor terminal 100. In addition, even in case the IP address 150 is changed and the cookie 120 is deleted, the determination upon the re-access of the visitor terminal 100 can be easily made by using the access information files 130 and 140.

The embodiment of the present invention can be embodied in a storage medium including instruction codes executable by a computer such as a program module executed by the computer. Besides, the data structure in accordance with the embodiment of the present invention can be stored in the storage medium executable by the computer. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes a certain information transmission medium.

The system and method of the present invention has been explained in relation to a specific embodiment, but its components or a part or all of its operation can be embodied by using a computer system having general-purpose hardware architecture.

The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. A method for generating access statistic data on an individual visitor to a web site, the method comprising:
(a) when a visitor terminal accesses the web site, reading out a unique ID from a userdata file implemented in the form of xml (extensible markup language) in such a way that data thereof can be stored in and retrieved from the visitor terminal by using userData Behavior;
(b) when an access history of the visitor terminal having the unique ID read out from the step (a) is stored in an access statistics DB, updating and storing the access history of the visitor terminal in the access statistics DB in combination with the read-out unique ID; and
(c) when the unique ID is not read out from the step (a) or the access history of the visitor terminal having the unique ID read-out in the step (a) is not stored in the access statistics DB, generating a unique ID corresponding to the visitor terminal, generating a userdata file in which the generated unique ID is written and storing the generated userdata file in the visitor terminal, and storing the access history of the visitor terminal in the access statistics DB in combination with the generated unique ID.

2. The method of claim 1, further comprising:
(d) generating statistic data on an individual visitor based on the access history stored in the access statistic DB and providing a manager with the generated statistic data.

3. A method for generating access statistic data on an individual visitor to a web site, the method comprising:
(a) when a visitor terminal accesses the web site, reading out a unique ID from a flash data file implemented in such a way that data thereof can be stored in and retrieved from the visitor terminal by using a SharedObject class of Macromedia Flash;
(b) when an access history of the visitor terminal having the unique ID read out from the step (a) is stored in an access statistics DB, updating and storing the access history of the visitor terminal in the access statistics DB in combination with the read-out unique ID; and
(c) when the unique ID is not read out from the step (a) or the access history of the visitor terminal having the unique ID read-out in the step (a) is not stored in the access statistics DB, generating a unique ID corresponding to the visitor terminal, generating a flash data file in which the generated unique ID is written and storing the generated flash data file in the visitor terminal, and storing the access history of the visitor terminal in the access statistics DB in combination with the generated unique ID.

4. The method of claim 3, further comprising:
(d) generating statistic data on an individual visitor based on the access history stored in the access statistic DB and providing a manager with the generated statistic data.
